(19) United States
(12) Patent Application Publication
(10) Pub. No.: US 2019/0172666 A1
(43) Pub. Date: Jun. 6, 2019

(54) VACUUM INTERRUPTER WITH A CERAMIC BODY AND AT LEAST ONE SHIELDING ELEMENT, AND METHOD FOR PRODUCING THE SAME

(71) Applicant: ABB Schweiz AG, Baden (CH)

(72) Inventor: Dietmar Gentsch, Ratingen (DE)

(21) Appl. No.: 16/257,142

(22) Filed: Jan. 25, 2019

Related U.S. Application Data
(63) Continuation of application No. PCT/EP2017/069059, filed on Jul. 27, 2017.

(30) Foreign Application Priority Data
Jul. 27, 2016 (EP) 16181568.3

(51) Int. Cl. H01H 33/662

(52) U.S. Cl. CPC H01H 33/66261; H01H 2033/66276; H01H 33/66207

(57) ABSTRACT

A vacuum interrupter includes: a ceramic body; and at least one tubelike inner shielding, which is located around an area of a fixed contact and a movable contact. The ceramic body is vacuum tightly closed at both ends with metal caps. The ceramic body is provided at its inner surface with a diameter reducing integrated collar. The shielding is provided with complementary outer bulges or convexities in its structure, adapted to the integrated collar such that the shielding lies against one side of the integrated collar, and is fixed in that position at an opposed side of the collar with a ring formed countering element.

### CROSS-REFERENCE TO PRIOR APPLICATION

This application is a continuation of International Patent Application No. PCT/EP2017/069059, filed on Jul. 27, 2017, which claims priority to European Patent Application No. EP 16181568.3, filed on Jul. 27, 2016. The entire disclosure of both applications is hereby incorporated by reference herein.

### FIELD

The invention relates to a vacuum interrupter with a ceramic body and at least one tubelike inner shielding, which is located around the area of a fixed contact and a movable contact, wherein the ceramic body is vacuum tightly closed at it both ends with metal caps, and method of producing the same.

### BACKGROUND

The actual solution of the vacuum interrupter which are used, to get a shielding on floating potential is to have two ceramics where the middle shield will be brazed in between. There are some other solutions available in the state of the art, to fix a middle shield inside a single ceramic as there are grooves or steps inside the ceramic cylinder to get a board where the metallic part can be fixed. All these solutions are needing a number of parts or there are tools needed to get burling at the shield.

A further problem is, to secure the shielding in its position, which is important for the technical performance of such a vacuum interrupter used in low- or medium voltage at the level of up to 72 kV.

### SUMMARY

In an embodiment, the present invention provides a vacuum interrupter, comprising: a ceramic body; and at least one tubelike inner shielding, which is located around an area of a fixed contact and a movable contact, the ceramic body being vacuum tightly closed at both ends with metal caps, wherein the ceramic body is provided at its inner surface with a diameter reducing integrated collar, and wherein the shielding is provided with complementary outer bulges or convexities in its structure, adapted to the integrated collar such that the shielding lies against one side of the integrated collar, and is fixed in that position at an opposed side of the collar with a ring formed countering element.

### BRIEF DESCRIPTION OF THE DRAWINGS

The present invention will be described in even greater detail below based on the exemplary FIGURES. The invention is not limited to the exemplary embodiments. Other features and advantages of various embodiments of the present invention will become apparent by reading the following detailed description with reference to the attached drawings which illustrate the following:

FIG. 1 shows an embodiment of a vacuum interrupter according to the invention.

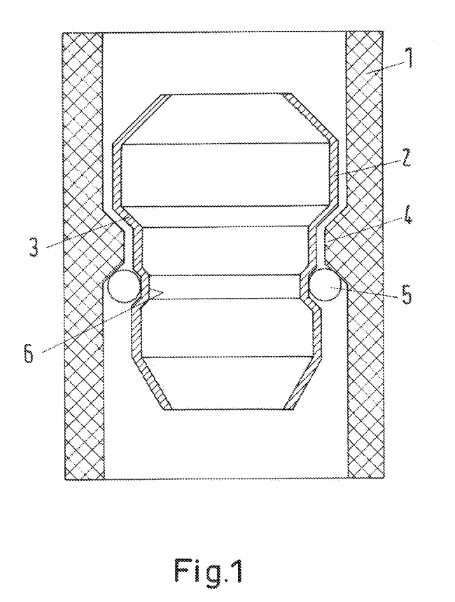

### DETAILED DESCRIPTION

So the object of the invention is, to enhance the positioning of the aforesaid middle shielding and to secure it in its final position with easy means.

According to that, the invention for a vacuum interrupter with a ceramic body and at least one tubelike inner shielding, which is located around the area of a fixed contact and a movable contact, wherein the ceramic body is vacuum tightly closed at it both ends with metal caps is, that the ceramic body is provided at its inner surface with a diameter reducing integrated collar, and the shielding is provided with complementary outer bulges or convexities in its structure, adapted to that aforesaid integrated collar in such, that the shielding lies against one side of the aforesaid collar, and is fixed in that position at the opposed side of the collar with a ring formed countering element.

In a further advantageous embodiment, that the ring formed countering element is a wire spiral spring, which is furthermore the contact spring of the shielding.

In a further advantageous embodiment, the shielding is provided with a circumferential concave groove or a local diameter reducing trench, in order to secure the position of the ring formed countering element.

In a further advantageous embodiment, the ring formed countering element is a so called worm spring.

According to the method for assembling a shielding inside a vacuum interrupter, with a ceramic body and at least one tubelike inner shielding, which is located around the area of a fixed contact and a movable contact, wherein the ceramic body is vacuum tightly closed at it both ends with metal caps, the invention is, that the ceramic body is provided at its inner surface with a diameter reducing integrated collar, and the shielding is provided with complementary outer bulges or convexities in its structure, that the shielding is positioned against one side of the aforesaid collar, and is fixed in that position at the opposed side of the collar with a ring formed countering element, and that after assembling or the ring formed countering element, the vacuum interrupter is treated by a brazing process, and that after the brazing process, the metal parts tends to shrink more than the ceramic body in such, that the shielding exactly fits to its final position at the collar inside the ceramic body of the vacuum interrupter.

In a further advantageous embodiment of the that, the worm spring is premanufactured out of a basical spring wire in such, that in a first step the worm spring will be treated by coating material, and in a second step cutting in its needed length, and in a third step positioned at the aforesaid position on the shielding.

Similar to that is the case of getting a spiral contact element.

A vacuum interrupter in vacuum tightly enclosed by a ceramic body with at least one tubelike inner shielding, which is located around the area of a fixed contact and a movable contact, wherein the ceramic body is vacuum tightly closed at it both ends with metal caps.

Concerning to the invention, the ceramic body is provided at its inner surface with a diameter reducing integrated collar. This collar is an integrated part of the tubelike cylindrical ceramic body. The shielding is provided with complementary outer bulges or convexities in its structure, adapted to that aforesaid integrated collar in such, that the shielding lies against one side of the aforesaid collar, and is fixed in that position at the opposed side of the collar with a ring formed countering element.

The ring formed countering element itself lies safe in this position in a groove or trench in the shielding and additionally versus the lower edge of the aforesaid collar.

By that, the shielding is safely locked in its position, due to silver plated part, the spring will be brazed during the warming treatment process to the shielding in the case, when the part is made of copper, the brazing will occur in situ.

Furthermore the rings formed countering element is a worm spring.

The worm spring is premanufactured out of a basical spring wire in such, that in a first step the worm spring will be treated by coating material, and in a second step cutting in its needed length, and in a third step positioned at the aforesaid position on the shielding.

The method of manufacture such a vacuum interrupter is, that the ceramic body is provided at its inner surface with a diameter reducing integrated collar, like described before, and the shielding is provided with complementary outer bulges or convexities in its structure, that the shielding is positioned against one side of the aforesaid collar, and is fixed in that position at the opposed side of the collar with a ring formed countering element, and that after assembling or the ring formed countering element, the vacuum interrupter is treated by a brazing process, and that after the brazing process, the metal parts tends to shrink more than the ceramic body in such, that the shielding exactly fits to its final position at the collar inside the ceramic body of the vacuum interrupter.

So in order to get this simple solution to fix a metal shielding at a single ceramic part there will be used an inner board where the formed shielding can be placed at the board, like described above. On the other side of the board, there will be placed the worm spring element which snaps inside the groove or trench of the metallic shielding. By the application of a jig in combination with the inserted metal shield, the ceramic collar will be placed in between.

In case the shield will be made of copper and the spring or worm spring will be made of a metal part covered with silver the brazing alloy will be established in-situ. During the brazing and the thermal expansion of the metal shield compared with the ceramic the metal part will shrink to the ceramic step during the cooling down to environment temperature. Due to that effect the part will be fixed by clamping to the ceramic board and fixed on floating potential.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### NUMBERING

1 ceramic body, insulator
2 shielding, middle shielding
3 bulge, convexity
4 integrated collar
5 wire spring, worm spring
6 groove or diameter reducing trench

What is claimed is:

1. A vacuum interrupter, comprising:
a ceramic body; and
at least one tubelike inner shielding, which is located around an area of a fixed contact and a movable contact, the ceramic body being vacuum tightly closed at both ends with metal caps,
wherein the ceramic body is provided at its inner surface with a diameter reducing integrated collar, and
wherein the shielding is provided with complementary outer bulges or convexities in its structure, adapted to the integrated collar such that the shielding lies against one side of the integrated collar, and is fixed in that position at an opposed side of the collar with a ring formed countering element.

2. The vacuum interrupter according to claim 1, wherein the ring formed countering element comprises a wire spiral spring, which is furthermore the contact spring of the shielding.

3. The vacuum interrupter according to claim 1, wherein the shielding is provided with a circumferential concave groove or a local diameter reducing trench to secure the position of the ring formed countering element.

4. The vacuum interrupter according to claim 1, wherein the ring formed countering element comprises a worm spring.

5. A method for assembling a shielding inside a vacuum interrupter, comprising:
providing a ceramic body;
providing at least one tubelike inner shielding, which is located around an area of a fixed contact and a movable contact, the ceramic body being vacuum tightly closed at both ends with metal caps;
providing the ceramic body at its inner surface with a diameter reducing integrated collar; and
providing the shielding is provided with complementary outer bulges or convexities in its structure,
wherein the shielding is positioned against one side of the integrated collar, and is fixed in that position at an opposed side of the collar with a ring formed countering element, and
wherein after assembling the ring formed countering element, the vacuum interrupter is treated by a brazing process, such that after the brazing process the metal parts tends to shrink more than the ceramic body in such that the shielding exactly fits to its final position at the integrated collar inside the ceramic body of the vacuum interrupter.

6. The method according to claim 5, wherein the ring formed countering element comprises a worm spring, and
wherein the worm spring is premanufactured out of a basic spring wire such that in a first step the worm spring is treated by coating material, and in a second step cut to its needed length, and in a third step is positioned at the position on the shielding.

7. The method according to claim 6, wherein the worm spring is premanufactured out of a basic spring and is used in an application for a contact spring part.
